(19) United States
(12) Patent Application Publication
(10) Pub. No.: US 2017/0276307 A1
(43) Pub. Date: Sep. 28, 2017

(54) LASER DECORATIVE LIGHTING FOR PROJECTING LASER

(71) Applicant: Yanping Wei, Shenzhen, Guangdong (CN)

(72) Inventor: Yanping Wei, Shenzhen, Guangdong (CN)

(21) Appl. No.: 15/505,265

(22) PCT Filed: Jul. 2, 2015
(86) PCT No.: PCT/CN2015/083187

§ 371 Date: Feb. 21, 2017

(51) Int. Cl. F21S 10/02; F21V 5/00

(52) U.S. Cl. CPC F21S 10/026; F21V 5/004

(57) ABSTRACT

The present invention is applicable in the technical field of laser lights, and provides a laser light for projecting laser which comprises a color adjustable laser light source and a dimmer, the dimmer comprises a rotator having a convex surface and a micro lens array arranged on the convex surface, and the micro lens array is formed by a plurality of closely arranged micro lens; each of the micro lens reflects the laser irradiating on a surface thereof so as to form a light spot on a light receiving surface, the rotator can rotate axially, such that the micro lens array can reflect an incident laser dynamically and scatteringly so as to form a light spot pattern having the same color with that of the incident laser on the light receiving surface.

### TECHNICAL FIELD

The present application relates to the technical field of laser lights, and more particularly, relates to a laser decorative lighting for projecting laser.

### BACKGROUND

A laser light for projecting laser is a device which uses lasers as a light source and obtains a desired projection effect by other dimming means, such as a landscape laser light, a stage Laser light, a garden Laser light, an advertising Laser light, and so on, they are all illumination Laser lights having much better render effects and are not used in daily life. Currently, the Laser light for projecting laser in the market usually diffracts a laser beam into a plurality of small light spots by two dimensional optical gratings, and projects the small light spots onto a light receiving surface so as to form a more beautiful pattern. However, there still exists a deficiency in this technology, since a white laser or a color laser being adopted is synthesized by a red light, a green light and a blue light, after being diffracted by the optical gratings, the red light, the green light and the blue light have different diffraction angles at the same diffraction order, for this reason, the three colored light are separated and red light spots, green light spots and blue light spots are formed respectively, such light spot has a single color, a fixed shape and a monotonous render effect, which can't meet diversified demands.

### BRIEF DESCRIPTION

A primary purpose of the present application is providing a Laser light for projecting laser, by the Laser light for projecting laser, the light spot colors and patterns can be diversified, and projection effect can be improved.

The present invention is implemented in this way: a Laser light for projecting laser which comprises a color adjustable laser light source and a dimmer configured for reflecting laser so as to form a light spot pattern, the dimmer comprises a rotator having a convex surface, and a micro lens array arranged on the convex surface, and the micro lens array is consisted of a plurality of micro lens arranged closely; each of the micro lens is configured for reflecting an incident laser on a surface thereof so as to form a light spot on a light receiving surface; the rotator can be rotated axially, such that the micro lens array can reflect the incident laser dynamically and scatteringly so as to form a light spot pattern having the same color with that of the incident laser on the light receiving surface.

In the present invention, the color adjustable laser light source is adopted to output lasers, and the micro lens array of the dimmer is used for reflecting the lasers scatteringly so as to form the light spot pattern, reflecting of the lasers by the micro lens array avoids a separation of monochromatic lasers, and thus colors of light spots can be set flexibly according to actual need; in addition, the red light spot, the green light spot and the blue light spot formed by a traditional diffraction method have fixed positions, pattern shapes of these light spots are monotonous and are lack in nature and flexibility, in this embodiment, the light spots are formed by the micro lens array, distribution of the light spots is not limited to a set pattern, and is more natural and beautiful, and the pattern shape can be flexible and changeable according to the variation of the dimmer.

### BRIEF DESCRIPTION OF THE DRAWINGS

FIG. 1 illustrates a structural schematic view of a laser projecting laser light provided by an embodiment of the present invention;

FIG. 2 illustrates a first structural schematic view of a dimmer of the laser projecting Laser light provided by the embodiment of the present invention;

FIG. 3 illustrates a top view structural schematic view of the dimmer in FIG. 2;

FIG. 4 illustrates a first light spot pattern effect view corresponding to the dimmer shown in FIG. 2;

FIG. 5 illustrates a second structural schematic view of the dimmer of the laser projecting Laser light provided by the embodiment of the present invention;

FIG. 6 illustrates a second light spot pattern effect view corresponding to the dimmer shown in FIG. 5;

FIG. 7 illustrates a third structural schematic view of the dimmer of the laser projecting Laser light provided by the embodiment of the present invention;

FIG. 8 illustrates a third light spot pattern effect view corresponding to the dimmer shown in FIG. 7.

### DETAILED DESCRIPTION

In order to make the purposes, technical solutions, and advantages of the present invention be clearer and more understandable, the present invention will be further described in detail hereinafter with reference to the accompanying drawings and embodiments. It should be understood that the embodiments described herein are only intended to illustrate but not to limit the present application.

Herein, the specific implementation of the present invention will be described in detail with reference to specific embodiments:

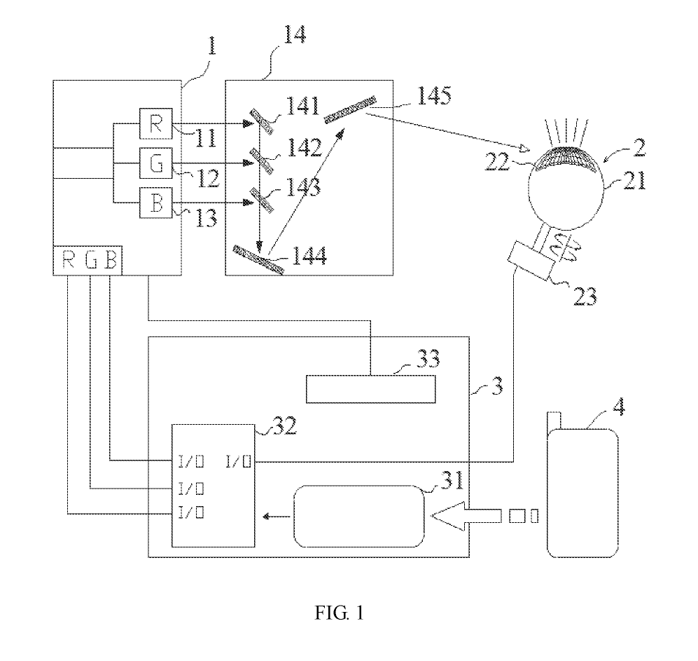

Please referring to FIG. 1, the embodiment of the present invention provides a Laser light for projecting laser comprises a color adjustable laser light source 1 and a dimmer 2 configured for reflecting laser so as to form a light spot pattern, wherein, the dimmer 2 comprises a rotator 21 having a convex surface and a micro lens array 22 arranged on the convex surface of the rotator 21, the micro lens array 22 is consisted of a plurality of closely arranged micro lens 221. The rotator 21 can be driven to rotate axially by a drive mechanism 23, and the micro lens array 22 is driven to rotate with the rotator 21; because the micro lens array 22 is arranged on the convex surface, the micro lens array 22 can reflect the incident laser scatteringly, which is similar to a reflection effect of a convex mirror, and because the micro lens array 22 is consisted of a plurality of micro lens, each of the micro lens can reflect the incident laser towards a certain direction so as to form a light spot at a light receiving surface, therefore, the whole of the micro lens array 22 can scatteringly reflect the incident laser towards different directions and won't result in a separation of different colored light, and a light spot pattern having the same color with that of the incident laser is further formed on the light receiving surface, the rotator 21 supports and rotates with the micro lens array 22, and a dynamic and colorful light spot pattern can be formed on the light receiving surface.

In the embodiment of the present invention, the color adjustable laser light source 1 can be adopted to output laser, and the laser is reflected scatteringly by the micro lens array 22 of the dimmer 2 so as to form the light spot pattern, the reflecting of the laser caused by the micro lens array 22 avoids a separation of monochromatic lasers, so that colors of light spots can be set flexibly according to the actual need; in addition, a red light spot, a green light spot and a blue light spot formed by a traditional diffraction method have fixed positions, monotonous pattern shapes and are lack of nature and flexibility, in the embodiment of the present invention, the light spots are formed by the micro lens array 22, distribution of the light spots is not limited to a set pattern, and is more natural and beautiful, and the pattern shape can be flexible and changeable according to the variation of the dimmer 2.

In the embodiment of the present invention, the Laser light for projecting laser further comprises a controller 3, the controller 3 comprises a receiving module 31 capable of receiving a first control signal and a control module 32 configured for transmitting a second control signal to the laser light source 1. The first control signal can be a signal regarding the intensity of three colors of red, green and blue emitting by a remote controller 4, after performing an information interaction between the receiving module 31 and the control module 32, the control module 32 outputs the second control signal for controlling a R module 11, a G module 12 and a B module 13 of the laser light source 1 to output a certain quantity of monochromatic lasers (i.e., a red laser, a green laser and a blue laser). The controller 3 can further comprise a power supply module 33 configured for supplying power for the controller 3 and the laser light source 1.

The laser light source 1 further comprises a light synthesizing and outputting module 14 configured for synthesizing three monochromatic lasers into a single laser beam and outputting the beam. Specifically, the light synthesizing and outputting module 14 can comprises a first reflection mirror 141, a second reflection mirror 142 and a third reflection mirror 143, the first reflection mirror 141 is configured for reflecting a red laser, the second reflection mirror 142 is configured for transmitting the red laser and reflecting a green laser, the third reflection mirror 143 is configured for transmitting the red laser and the green laser and reflecting a blue laser, and the three monochromatic lasers are synthesized into a single laser beam. The light synthesizing and outputting module 14 further comprises a fourth reflection mirror 144 and a fifth mirror reflection 145, the red laser, the green laser and the blue laser are synthesized and transmitted to the fourth reflection mirror 144, and then reflected by the fifth reflection mirror 144 to the fifth reflection mirror 145, and finally reflected by the fifth reflection mirror 145 to the dimmer 2. Of course, the light synthesizing and outputting module 14can also adopt other structures as long as it can achieve that monochromatic lasers are synthesized into a single laser beam and then are transmitted to the dimmer 2. Moreover, according to actual need, a quantity relative ratio of red laser, green laser and blue laser can be regulated and the laser of a desired color can be further obtained.

In this embodiment, preferably, the micro lens array 22 is formed by a plurality of independent plane-shaped micro lens 221 adhered to or embedded in the convex surface, the plane-shaped micro lens 221 is prone to be processed in batches, moreover, since the micro lens 221 have smaller dimensions and longer transmission distances, the plane-shaped micro lens 221 can parallelly reflect parallel light, so that it is more convenient to form the light spots, however, a convex or concave micro lens has a divergence or a convergence effect on the parallel light, under the circumstance of a long transmission distance, the light spots are prone to be enlarged, thereby causing the blur of light spots.

Further, a mortar cutting machine used for cutting crystal oscillators in the technical field of electronics is preferably used for cutting out independent micro lens 221, when the mortar cutting machine is adopted to cut out the micro lens 221, cutting of micro lens 221 with very small size can be achieved, and cutting edges of the micro lens 221 are neat and sharp and have small chamfers, which is good for forming of the light spot pattern. The micro lens 221 are affixed to the surface of double foam tape, thereby forming an array structure, then the whole of the micro lens array 22 is pasted on the convex surface of the rotator 21. As for the micro lens 221 formed by independent cutting, in one aspect, cutting of the micro lens 221 with smaller sizes can be achieved, meanwhile, the micro lens 221 formed by cutting have sharp edges, and chipping edges of reflection surfaces of the micro lens 221 are less than 0.05 mm. Since reflection of lasers caused by the chamfers may result in undesirable noises of the light spot pattern, the smaller the chamfers, the clearer and more beautiful the patterns, therefore, the micro lens 221 of this embodiment can exclude this harmful influence effectively.

In this embodiment, the shape of the light spot pattern is mainly influenced by the structure of the micro lens array 22, the micro lens array 22 is affixed to or embedded in the surface of the rotator 21, therefore, the structure of the rotator 21 and the structure of the micro lens array 22 are crucial.

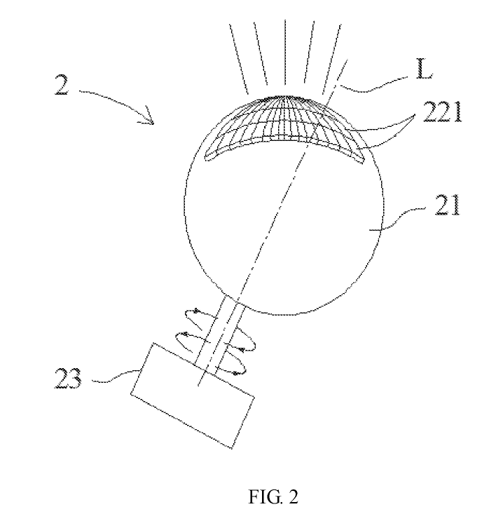

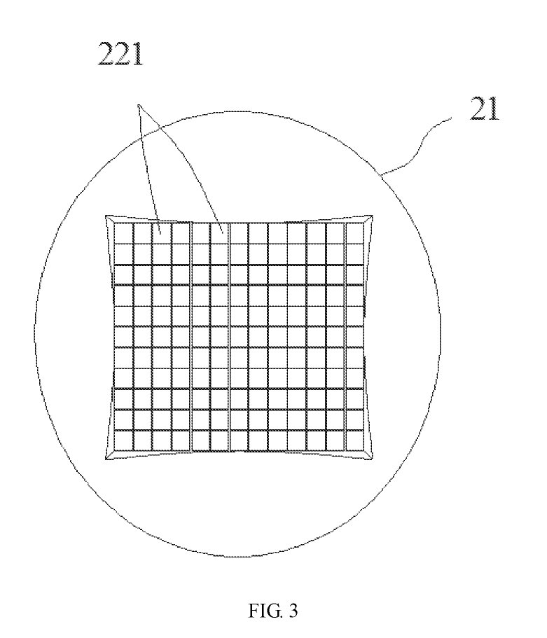

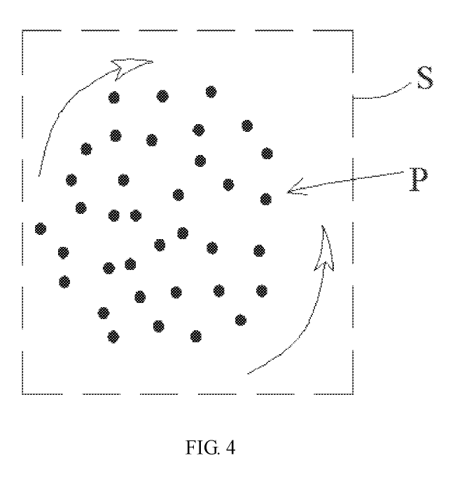

Specifically, as an implementation method, as shown in FIGS. 1-3, the rotator 21 can be sphere-shaped, the micro lens array 22 can be a matrix having M rows and N columns, wherein both M and N are positive integers more than 1, preferably, M=N or M≈N, the micro lens 221 are rectangular and are prone to be cut out. A rotating axis L is coincident with a diameter that passes through a center of the micro lens array 22. Lasers are irradiated in an oblique upper direction of the micro lens array 22 and are reflected by the micro lens array 22 to a receiving surface S so as to form a light spot pattern P. When the rotator 21 is in a stationary state, the light spot pattern is a static pattern, in the process of a clockwise rotation or a counterclockwise rotation of the rotator 21, the light spot pattern P is a dynamic pattern. As shown in FIG. 4, the light spot pattern P formed by the dimmer 2 having the sphere-shaped rotator 21 and the micro lens array 22 that matches with the sphere-shaped rotator 21 is very natural, has various shapes and abundant colors, which is just like a starry sky in the dark.

Furthermore, the size of the sphere-shaped rotator 21 should matches with sizes of the micro lens 221 reasonably, if a radius of a curvature of the sphere-shaped rotator 21 is much larger, a smaller divergence angle of the micro lens array 22 will be caused, and a spread reflection effect is unobvious, which is not good for the forming of the light spot pattern that can be identified. If the radius of the curvature is smaller, there exists a larger gap between two micro lens 221 adjacent to each other, light irradiated into the gap is wasted, and an utilization ratio of light is effected; moreover, if the projection angle is too large, and the density of the light spots will be too small which will affect the visual effect. Preferably, a diameter of the sphere-shaped rotator 21 is between 20 mm and 50 mm, and is 30 mm preferably, a side length of each of the micro lens 221 is between 0.3 mm and 2 mm, and is 0.7 mm*0.7 mm preferably, the gap between two adjacent micro lens 221 is less than 0.1 mm. The projection angle of the micro lens array 22 is between 70 degrees and 90 degrees, and a dimension of a laser light spot irradiated on the micro lens array 22 is bigger than 30 mm*30 mm.

Furthermore, a surface smooth of each of the micro lens 221 is 60/40 preferably, there are no bubbles on the surface, the reflectivity of visible light having a wave length between 400 nm and 700 nm is more than 99%, such that a better light energy utilization ratio can be ensured.

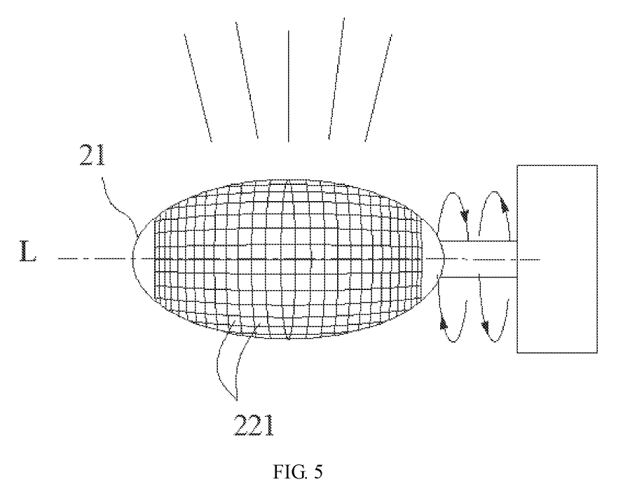

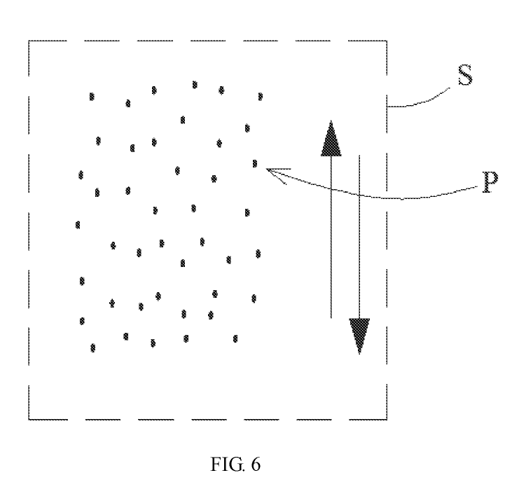

As another implementation method, as shown in FIG. 5, the rotator 21 can be ellipsoid-shaped, a rotating axis L is coincident with a long axis of the ellipsoid-shaped rotator 21, the micro lens array 22 is formed by a plurality of micro lens annular bands connected closely in the direction of the rotating axis L, each of the micro lens annular bands is formed by the plurality of micro lens 221 arranged circumferentially around the rotating axis L. The surface of the ellipsoid-shaped rotator 21 is divided by longitude and latitude, the longitude is the direction parallel to the long axis direction, and the latitude is the direction parallel to the short axis direction, the micro lens array 22 is consisted of the plurality of micro lens annular bands parallel to the latitude, a light reflection direction of each of the micro lens annular bands has a same angle with respect to the rotating axis L. In actual application, part areas of the surface of the rotator 21 are irradiated by parallel light beam in the direction perpendicular to the rotating axis L, the irradiated micro lens 221 reflects the light beam scatteringly, and a dynamic light spot pattern P is formed on the receiving surface S with the rotation of the rotator 21, as shown in FIG. 6, the light spot pattern P forms a raindrop falling effect and is very aesthetic.

As another implementation method, the rotator 21 can be spindle-shaped, a rotating axis L is coincident with a connecting line that connects two top points of the spindle-shaped rotator 21, the spindle-shaped rotator 21 can have a smooth surface, at this moment, the micro lens array 22 is formed by a plurality of truncated cone-shaped micro lens annular bands arranged in the direction of the rotating axis L, each of the annular lens annular bands is formed by a plurality of micro lens 221 arranged circumstantially around the rotating axis L. The structure of the spindle-shaped rotator 21 is similar to that of the ellipsoid-shaped rotator, and a pattern effect of the spindle-shaped rotator 21 is similar to that of the ellipsoid-shaped rotator too.

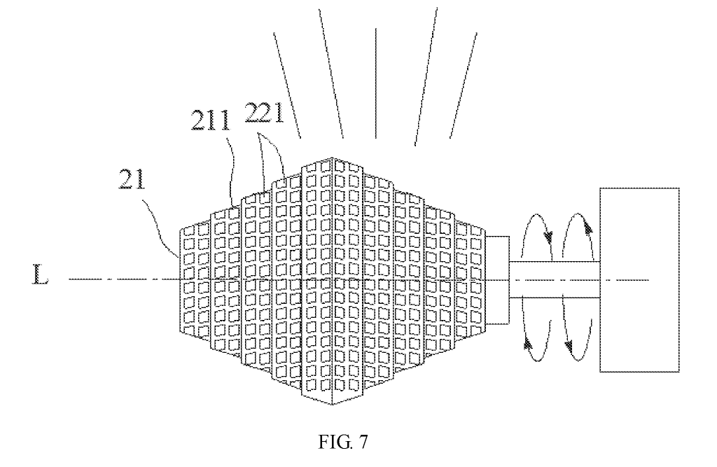

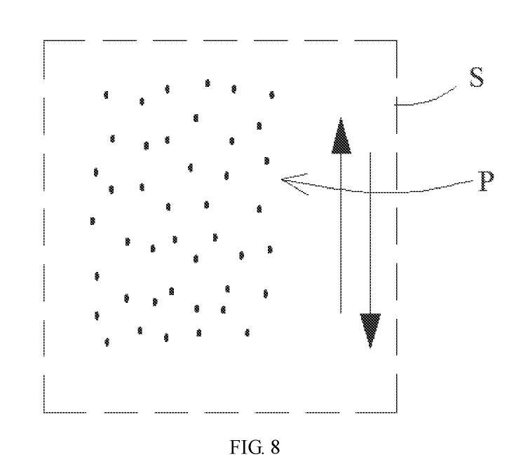

As shown in FIG. 7, the spindle-shaped rotator can also have unsmooth surfaces, the spindle-shaped rotator has multi-step truncated cone-shaped step surfaces 211 around the rotating axis L, each of the truncated cone-shaped step surfaces 211 is provided thereon with at least one micro lens annular bands formed by the micro lens 221. Each of the truncated cone-shaped surfaces 211 has a certain angle with respect to the rotating axis L, there may be a same included angle or different included angles between different truncated cone-shaped step surfaces 211 and the rotating axis L. As shown in FIG. 8, the structure of the spindle-shaped rotator is similar to that of the ellipsoid-shaped rotator, and a pattern effect of the spindle-shaped rotator is similar to that of the ellipsoid-shaped rotator too.

Dimensional parameters of the micro lens array 22 on the surface of the sphere-shaped rotator 21 can be the same with that of the micro lens array 22 on the surfaces of the aforesaid ellipsoid-shaped rotator and the aforesaid spindle-shaped rotator.

The structures of the embodiments of the present invention are described above, in some other feasible embodiments, other structures can also be applied in the rotator 21, a technical solution is considered as being feasible as long as the surface of the rotator 21 is provided with the micro lens array 22, and the micro lens array 22 scatteringly reflects the lasers to form the light spot pattern in this technical solution.

The aforementioned embodiments are only preferred embodiments of the present application, and are not used for limiting the present invention. Any modification, equivalent replacement, improvement, and so on, which are made within the spirit and the principle of the present application, should be included in the protection scope of the present application.

1. A laser light for projecting laser comprising a color adjustable laser light source and a dimmer configured for reflecting laser so as to form a light spot pattern, the dimmer comprises a rotator having a convex surface, and a micro lens array arranged on the convex surface, and the micro lens array is consisted of a plurality of closely arranged micro lens; each of the micro lens is configured for reflecting an incident laser on a surface thereof so as to form a light spot on a light receiving surface; the rotator can be rotated axially, such that the micro lens array can reflect the incident laser dynamically and scatteringly so as to form a light spot pattern having the same color with that of the incident laser on the light receiving surface.

2. The laser light for projecting laser according to claim 1, wherein the micro lens array is formed by a plurality of independent plane-shaped micro lens affixed to the convex surface.

3. The laser light for projecting laser according to claim 1, wherein the rotator is sphere-shaped, the micro lens array is a matrix form having M rows and N columns; wherein both M and N are positive integers more than 1, a rotating axis of the rotator is coincident with a diameter that passes through a center of the micro lens array.

4. The laser light for projecting laser according to claim 3, wherein a diameter of the sphere-shaped rotator is between 20 mm and 50 mm, the micro lens are rectangle-shaped and each of the micro lens has a side length that is between 0.3 mm to 2 mm.

5. The laser light for projecting laser according to claim 1, wherein the rotator is ellipsoid-shaped, the rotating axis of the rotator is coincident with a long axis of the ellipsoid-shaped rotator, the micro lens array is formed by a plurality of micro lens annular bands connected closely in the rotating axis direction, and each of the micro lens annular bands is formed by the plurality of micro lens arranged circumferentially around the rotating axis.

6. The laser light for projecting laser according to claim 1, wherein the rotator is spindle-shaped, the rotating axis of the rotator is coincident with a connecting line that connects two top points of the spindle-shaped rotator; the micro lens array is formed by a plurality of truncated cone-shaped micro lens annular bands arranged in the rotating axis direction, and each of the micro lens annular bands is formed by the plurality of micro lens arranged circumferentially around the rotating axis.

7. The laser light for projecting laser according to claim 6, wherein the truncated cone-shaped rotator has a smooth surface, and the plurality of micro lens annular bands abut from each other and are connected closely and sequentially on the surface.

8. The laser light for projecting laser according to claim 6, wherein the truncated cone-shaped rotator has multi-step truncated cone-shaped step surfaces around the rotating axis, and each of the truncated cone-shaped step surfaces is provided with at least one micro lens annular band consisted of a plurality of micro lens.

9. The laser light for projecting laser according to claim 1, wherein a chipping edge of a reflecting surface of each of the micro lens is less than 0.05 mm.

10. The laser light for projecting laser according to claim 1, wherein the laser light source comprises a R module configured for emitting a red beam, a G module configured for emitting a green beam, a B module configured for emitting a blue beam, and a light synthesizing and outputting module configured for synthesizing the red beam, the green beam and the blue beam into a single laser beam and outputting the laser beam.

11. The laser light for projecting laser according to claim 2, wherein the rotator is sphere-shaped, the micro lens array is a matrix form having M rows and N columns; wherein both M and N are positive integers more than 1, a rotating axis of the rotator is coincident with a diameter that passes through a center of the micro lens array.

12. The laser light for projecting laser according to claim 2, wherein the rotator is ellipsoid-shaped, the rotating axis of the rotator is coincident with a long axis of the ellipsoid-shaped rotator, the micro lens array is formed by a plurality of micro lens annular bands connected closely in the rotating axis direction, and each of the micro lens annular bands is formed by the plurality of micro lens arranged circumferentially around the rotating axis.

13. The laser light for projecting laser according to claim 2, wherein the rotator is spindle-shaped, the rotating axis of the rotator is coincident with a connecting line that connects two top points of the spindle-shaped rotator; the micro lens array is formed by a plurality of truncated cone-shaped micro lens annular bands arranged in the rotating axis direction, and each of the micro lens annular bands is formed by the plurality of micro lens arranged circumferentially around the rotating axis.

14. The laser light for projecting laser according to claim 2, wherein a chipping edge of a reflecting surface of each of the micro lens is less than 0.05 mm.

15. The laser light for projecting laser according to claim 2, wherein the laser light source comprises a R module configured for emitting a red beam, a G module configured for emitting a green beam, a B module configured for emitting a blue beam, and a light synthesizing and outputting module configured for synthesizing the red beam, the green beam and the blue beam into a single laser beam and outputting the laser beam.
